(19) United States
(12) Patent Application Publication
(10) Pub. No.: US 2014/0056029 A1
(43) Pub. Date: Feb. 27, 2014

(54) BACKLIGHT MODULE

(71) Applicants: Hu He, Shenzhen (CN); Kuang Yao Chang, Shenzhen (CN)

(72) Inventors: Hu He, Shenzhen (CN); Kuang Yao Chang, Shenzhen (CN)

(73) Assignee: Shenzhen China Star Optoelectronics Technology Co. Ltd., Shenzhen, Guangdong (CN)

(21) Appl. No.: 13/695,285

(22) PCT Filed: Aug. 29, 2012
(86) PCT No.: PCT/CN12/80720

§ 371 Date: Oct. 30, 2012

(30) Foreign Application Priority Data
Aug. 21, 2012 (CN) 201210298911.8

(51) Int. Cl. F21V 8/00

(52) U.S. Cl. CPC G02B 6/0011
USPC 362/612; 362/611

(57) ABSTRACT

A backlight module comprises: a light emitting device; a light guide plate that has a plurality of light guide prisms; a first prism assembly that comprises a first base body and a plurality of first prisms arranged on the light emergent surface of the first base body; a second prism assembly that comprises a second base body and a plurality of second prisms, wherein the extending direction of the second prisms is vertical to that of the first prisms. By way of the light guide prisms of the light guide plate extending in the parallel direction to the extending direction of the first prisms, the light beam with a large angle propagating through the light guide plate will not be guided out by the prisms near the light incident side, so as to increase the light mixing area and subsequently avoid the presence of alternately dark and bright hotspot.

### FIELD OF THE INVENTION

The present invention relates to a flat-panel display, and specifically to a backlight module for the flat-panel display.

### BACKGROUND OF THE INVENTION

With the continuous increase of the efficiency of LED, the backlight design of LED TV is developing correspondingly, from the initial incident light in four lateral directions; to in two lateral directions, to in a single lateral direction so far, whereby, the light incidence from short side is gradually predominant. In addition, the frame of LED TV becomes more and more narrow, in order to effect the beautiful appearance. With the development of light guide plate technology, the light guide plate with micro-structure appears in the design more frequently. FIG. 1 shows the structure diagram of the light guide plate, as shown in FIG. 1, the light guide plate is provided with a plurality of parallel adjacent light guide prisms 120 onto its light emergent top surface 110, wherein, the light guide prisms 120 extend in a certain direction on the light guide plate, for example in FIG. 1, in the long-edge direction of the guide light plate. The advantage brought by such structure is that, the light emitted by a light emitting device (such as a light source of a LED) is partly converged, in particular for the light beam with large angle, which may contribute to a lateral type local dimming (local DIM) or to backlight light scanning in a shutter glasses mode. In addition, the efficiency of a light guide plate with a light guide prism structure has been increased compared with the common flat light guide plate, because the converged light beam with a large visual angle can be recycled. Finally, the light guide plate with a micro-structure also has a function of covering. Based on the above advantages, more and more light guide plates with micro-structure have been applied.

FIG. 2 shows a cross section diagram of a light emitting device 200 and a light guide plate 100 in the backlight module. Wherein, the light incident side surface 130 of the light guide plate 100 is arranged parallel to and adjacent to the light emergent side surface 210 of the light emitting device 200. The light guide prisms extend in the light emergent direction of the light emitting device. Here, the light emergent direction is approximate vertical to the light emergent side surface 210. The light guide prisms 120 provided on the light guide plate 100 serve for light convergence, such that a large portion of emergent light from the light guide plate 100 are the light beam with a large angle (shown as the arrows in the FIG. 2), whereby such light beam can be guided further.

However, in the existing backlight module, a prism assembly 10 is also provided above the light emergent top surface 140 of the light guide plate 100. As shown in FIG. 3, the prism assembly 10 comprises a base body 11 and a plurality of prisms 12 which are arranged on the light emergent surface of the base body 11. Wherein, the prisms 12 are positioned parallel to and adjacent to each other, and the extending direction of the prisms 12 is vertical to that of the light guide prisms 120, such that the light beam with a large angle in FIG. 2 may be guided out from the light guide plate 100 by the prisms 12, shown as the arrows in FIG. 3, as a result, such light beam can not be guided further in the light guide plate 100.

FIG. 4 shows a decomposition of the light beam in FIG. 3 during passing through the prisms 12. After the incident light beam 01 from the light guide plate 100 passes through the prisms 12, the resulted useful light beam 02 enter into other prism assembly or optical film, the resulted light beam with a large angle 03 is guided out by the prisms 12, such portion of guided out light beam can not be guided further in the light guide plate 100. In addition, recycle light beam 04 comes from other prism assembly or optical film, and recycle light beam 05 comes from the prisms 12 themselves. As most of the light beam has been guided out at the light incident side, the light mixing region is reduced. Consequently, the light intensity between LED light sources is less than that at the right ahead of LED light sources, such that alternately dark and bright phenomenon appears, namely hotspot. Generally, in order to eliminate such mura, the distance from the LED light sources to a visible area has to be increased, or the distance between each other of LED light sources is reduced. The former will increase the width of the frame, and the latter will increase the number of the LED light sources, such that the cost-efficiency is relative low.

### SUMMARY OF THE INVENTION

The problem to be solved by the present invention is that, in the prior art, by reason of the light guide prisms of the light guide plate extending in the vertical direction to the extending direction of the prisms arranged above the light guide plate, the light beam with a large angle propagating through the light guide plate is guided out by the prisms, such that mura appears. In light of the above problem, it is an object of the present invention to provide a backlight module.

To achieve the above object, a backlight module according to the present invention has a structure that comprises:

a light emitting device;

a light guide plate that has a plurality of light guide prisms adjacent to and parallel to each other, onto its light emergent top surface, wherein the light guide prisms extends in the light emergent direction of the light emitting device;

a first prism assembly 300 that comprises a first base body and a plurality of first prisms arranged on the light emergent surface of the first base body, wherein, the first prisms are arranged parallel to and adjacent to each other, the first base body is arranged parallel to and above the light emergent top surface, and the first prisms extend in the in the light emergent direction of the light emitting device;

a second prism assembly that comprises a second base body and a plurality of second prisms arranged on the light emergent surface of the second base body, wherein, the second prisms are arranged parallel to and adjacent to each other, the second base body is arranged above and parallel to the light emergent surface of the first base body, and the extending direction of the second prisms is vertical to that of the first prisms.

Preferably, the cross section of the light guide prisms is shaped as sector or triangle.

Preferably, the cross section of the first prisms is shaped as sector or triangle; and the cross section of the second prisms is shaped as sector or triangle.

Preferably, the shape of the first prisms is same with that of the second prisms.

Preferably, the backlight module further comprises a first optical film arranged between and parallel to the light guide plate and the first prism assembly.

Preferably, the first optical film 500 is served as a diffusion film or a micro-prism film.

Preferably, the backlight module further comprises a second optical film arranged above and parallel to the second prism assembly.

Preferably, the second optical film is served as a diffusion film or a micro-prism film or a brightness enhancement film.

Preferably, the light emitting device comprises a first light emitting unit and a second light emitting unit respectively arranged on the opposite sides of the light guide plate.

Preferably, the light emitting device comprises a plurality of LED light sources.

The produced beneficial effect by the present invention is shown as followed: by way of the light guide prisms of the light guide plate extending in the parallel direction to the extending direction of the first prisms which is provided above the light guide plate, the light beam with a large angle propagating through the light guide plate will not be guided out by the prisms near the light incident side, so as to increase the light mixing area and subsequently avoid the presence of alternately dark and bright hotspot. As a result, the display effect is improved.

### BRIEF DESCRIPTION OF THE DRAWINGS

The present invention is described with reference to the accompanying drawings.

FIG. 1 shows the structure diagram of the light guide plate according the embodiment of the present invention;

FIG. 2 shows a cross section diagram of a light emitting device 200 and a light guide plate 100 in the backlight module;

FIG. 3 shows a schematic view of the light beam in the light guide plate in FIG. 1;

FIG. 4 shows a decomposition of the light beam in FIG. 3 during passing through the prisms;

FIG. 5 is a schematic view of the backlight module according to the embodiment of the present invention;

FIG. 6 is a sectional view of FIG. 5 looking in the direction of the arrow A;

FIG. 7 is a schematic view illustrating the relative position between the first prism assembly and second prism assembly;

FIG. 8 is a schematic view of the backlight module according to the preferred embodiment of the present invention;

FIG. 9 shows the visual angle profile.

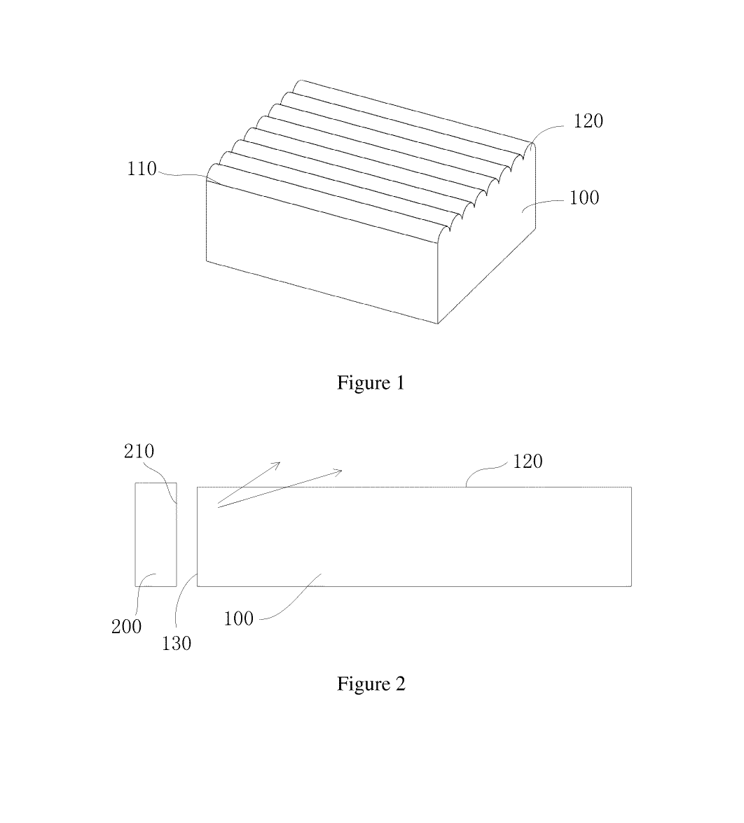

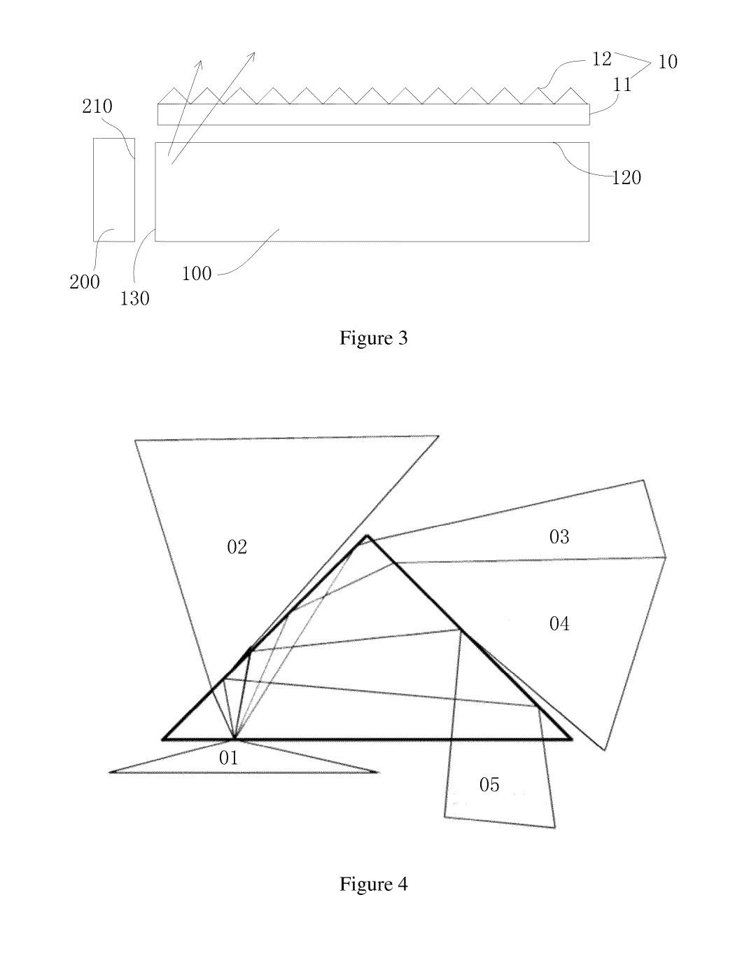

### DETAILED DESCRIPTION OF THE PREFERRED EMBODIMENT

In order to make the object, technical solution and advantages of the present invention well known, the present invention is more specifically described in the following paragraphs by reference to the drawings attached only by way of example.

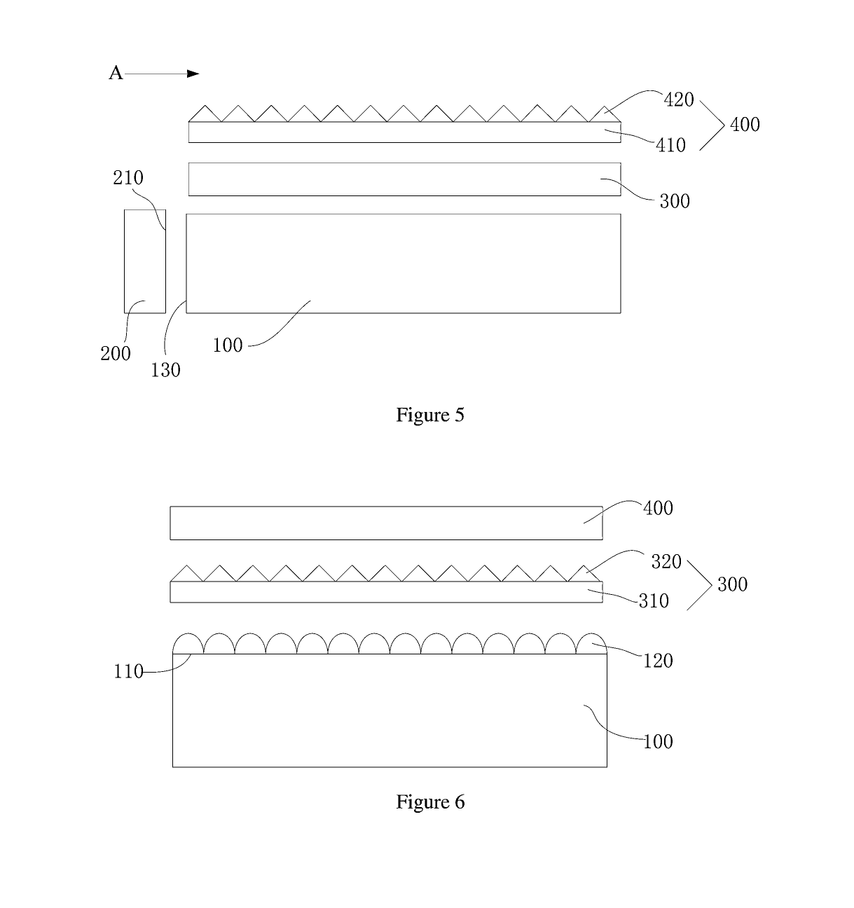

FIG. 5 is a schematic view of the backlight module according to the embodiment of the present invention; and FIG. 6 is a sectional view of FIG. 5 looking in the direction of the arrow A. As shown in FIGS. 5 and 6, the backlight module according to the embodiment of the present invention a light emitting device 200, a light guide plate 100, a first prism assembly 300 and a second prism assembly 400.

The light emitting device 200 comprises a plurality of LED light sources which emit light beam in the direction approximate vertical to a light emergent side surface 210, so as to enter into the light guide plate 100.

The light guide plate 100 is arranged beside the light emitting device 200, wherein, a light emergent side surface 210 of the light emitting device 200 is facing and parallel to a light incident side surface 130 of the light guide plate 100, after the light beam from the LED light sources is emitted out from the light emergent side surface 210, it enters into the light guide plate 100 via the light incident side surface 130. Herein, the light guide plate 100 has a micro-structure; in particular, the light guide plate 100 has a plurality of light guide prisms 120 adjacent to and parallel to each other, onto its light emergent top surface 110, and such light guide prisms 120 extends in the light emergent direction of the light emitting device 200. The cross section of the light guide prisms 120 is shaped as sector or triangle. The cross section of the light guide prisms 120 shown in the figure is shaped as sector, but it is not limited to the invention. It is possible that the cross section of the light guide prisms 120 is shaped as triangle, preferably as isosceles triangle with two equal sides having common vertices.

The first prism assembly 300 comprises a first base body 310 and a plurality of first prisms 320 which are arranged on the light emergent surface of the first base body 310. The first prism assembly 300 is arranged parallel to and above the light guide plate 100; in particular, the first base body 310 is arranged parallel to and above the light emergent top surface 110 of the light guide plate 100. The first base body 310 has a first light incident surface and a first light emergent surface, wherein, the first light incident surface faces toward the light emergent top surface 110 of the light guide plate 100, for receiving the light beam outputted from the light emergent top surface 110 of the light guide plate 100. The first prisms 320 are arranged onto the first light emergent surface in the forward direction, that is the bottom surface of the first prisms 320 is located onto the first light emergent surface, and the first prisms 320 extend in the in the light emergent direction of the light emitting device 200. From the above it is known that the extending direction of the light guide prisms 120 is parallel to that of the first prisms 320. The cross section of the first prisms 320 is shaped as sector or triangle. The cross section of the first prisms 320 shown in the figure is shaped as isosceles triangle with two equal sides having common vertices.

The second prism assembly 400 comprises a second base body 410 and a plurality of second prisms 420 which are arranged on the light emergent surface of the second base body 410. The second prism assembly 400 is arranged parallel to and above the first prism assembly 300; in particular, the second base body 410 is arranged above the first prism assembly 300 and parallel to first base body 310. The second base body 410 has a second light incident surface and a second light emergent surface, wherein, the second light incident surface faces toward the first light emergent surface and the first prisms 320, for receiving the light beam outputted from the second prisms 420. The second prisms 420 are arranged onto the second light emergent surface in the forward direction, that is the bottom surface of the second prisms 420 is located onto the second light emergent surface, and the second prisms 420 extend in the in direction which is vertical to the light emergent direction of the light emitting device 200. From the above it is known that the extending direction of the second prisms 420 is vertical to that of the first prisms 320. The cross section of the second prisms 420 is shaped as sector or triangle. The cross section of the second prisms 420 shown in the figure is shaped as isosceles triangle with two equal sides having common vertices. In addition, preferably the structure configuration of the first prisms 320 is exactly same to that of the second prisms 420, and their extending directions are vertical to each other.

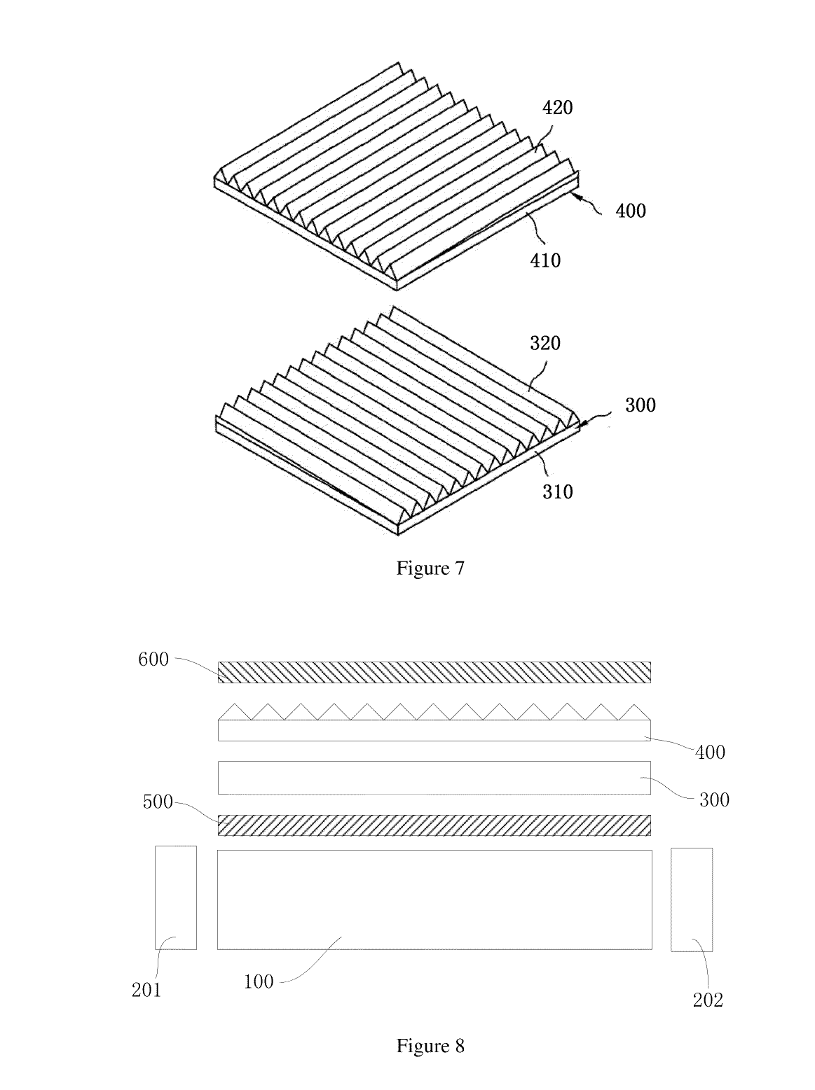

In order to more clearly illustrating the relative position between the first prism assembly 300 and second prism assembly 400, FIG. 7 is a schematic view illustrating the relative position between the first prism assembly 300 and second prism assembly 400. It is clearly shown that extending directions of first prisms 320 and the second prisms 420 are vertical to each other.

In the preferred embodiment of the present invention, for example shown in FIG. 8, the backlight module according to the embodiment of the present invention further comprises a first optical film 500 arranged between and parallel to the light guide plate 100 and the first prism assembly 300. The first optical film 500 may be served as a diffusion film or a micro-prism film. Preferably, the backlight module further comprises a second optical film 600 arranged above and parallel to the second prism assembly 400. The second optical film 600 may be served as a diffusion film or a micro-prism film or a dual brightness enhancement film (DBEF) produced by 3M company. Preferably, the light emitting device 200 comprises a first light emitting unit 201 and a second light emitting unit 202 respectively arranged on the opposite sides of the light guide plate 100. The first light emitting unit 201 and the second light emitting unit 202 respectively comprises a plurality of LED light sources, for emitting light beam toward the light guide plate 100. Similarity, the light guide prisms 120 extends in the light emergent direction of the first light emitting unit 201 and the second light emitting unit 202.

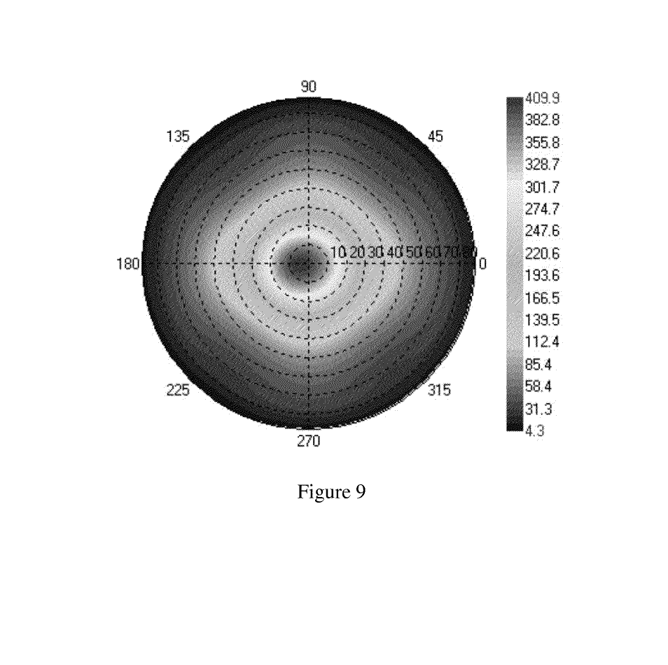

Based on the above description, we are known that, by way of the prism sheet which is provided above the light guide plate with light guide prisms and with its extending direction parallel to that of the light guide prisms, the light beam with a large angle propagating through the light guide plate is not guided out near the light incident side, so as to increase the light mixing area and subsequently avoid the presence of alternately dark and bright hotspot. As a result, the display effect is improved. Furthermore, by reason of the light incidence from short side, the direction of the light guide prisms of the light guide plate is horizontal, so that the formed visual angle in the horizontal direction is larger that by flat light guide plate. In the case where such type of light guide plate is employed, the requirement of visual angle is satisfied, as shown by the visual angle profile in FIG. 9.

While the invention has been described in terms of various specific embodiments, those skilled in the art will recognize that the invention can be practiced with modification within the spirit and scope of the claims.

1. A backlight module comprising:
a light emitting device;
a light guide plate that has a plurality of light guide prisms adjacent to and parallel to each other, onto its light emergent top surface, wherein the light guide prisms extends in the light emergent direction of the light emitting device;
a first prism assembly 300 that comprises a first base body and a plurality of first prisms arranged on the light emergent surface of the first base body, wherein, the first prisms are arranged parallel to and adjacent to each other, the first base body is arranged parallel to and above the light emergent top surface, and the first prisms extend in the in the light emergent direction of the light emitting device;
a second prism assembly that comprises a second base body and a plurality of second prisms arranged on the light emergent surface of the second base body, wherein, the second prisms are arranged parallel to and adjacent to each other, the second base body is arranged above and parallel to the light emergent surface of the first base body, and the extending direction of the second prisms is vertical to that of the first prisms.

2. A backlight module according to claim 1, wherein the cross section of the light guide prisms is shaped as sector or triangle.

3. A backlight module according to claim 1, wherein the cross section of the first prisms is shaped as sector or triangle; and the cross section of the second prisms is shaped as sector or triangle.

4. A backlight module according to claim 3, wherein the shape of the first prisms is same with that of the second prisms.

5. A backlight module according to claim 1, wherein the backlight module further comprises a first optical film arranged between and parallel to the light guide plate and the first prism assembly.

6. A backlight module according to claim 5, wherein the first optical film 500 is served as a diffusion film or a micro-prism film.

7. A backlight module according to claim 1, wherein the backlight module further comprises a second optical film arranged above and parallel to the second prism assembly.

8. A backlight module according to claim 7, wherein the second optical film is served as a diffusion film or a micro-prism film or a brightness enhancement film.

9. A backlight module according to claim 1, wherein the light emitting device comprises a first light emitting unit and a second light emitting unit respectively arranged on the opposite sides of the light guide plate.

10. A backlight module according to claim 1, wherein the light emitting device comprises a plurality of LED light sources.
